(19) United States
(12) Patent Application Publication
(10) Pub. No.: US 2020/0077010 A1
(43) Pub. Date: Mar. 5, 2020

(54) IMAGING DEVICE, IMAGING METHOD, AND INFORMATION STORAGE DEVICE

(71) Applicant: OLYMPUS CORPORATION, Tokyo (JP)

(72) Inventor: Toshiyuki NOGUCHI, Tokyo (JP)

(73) Assignee: OLYMPUS CORPORATION, Tokyo (JP)

(21) Appl. No.: 16/674,659

(22) Filed: Nov. 5, 2019

Related U.S. Application Data
(63) Continuation of application No. PCT/JP2017/018348, filed on May 16, 2017.

(51) Int. Cl. H04N 5/235; H04N 9/04; G06T 7/55; G06T 7/00; G02B 7/34; G02B 5/20

(52) U.S. Cl. CPC H04N 5/2354; H04N 9/0455; G06T 7/55; G06T 7/0002; G06T 2207/30168; G02B 5/201; G06T 2207/10024; G06T 2207/10152; G06T 2207/10048; G02B 7/34

(57) ABSTRACT

An imaging device includes: an optical filter 12 that divides a pupil of an imaging optical system 10 into a first pupil that transmits visible light and a second pupil that transmits invisible light; an image sensor 20 that is sensitive to the visible light and the invisible light; and a processor that generates a first pupil image as an image of the visible light and a second pupil image as an image of the invisible light based on an image captured by the image sensor 20, and detects a phase difference between the first pupil image and the second pupil image.

### CROSS REFERENCE TO RELATED APPLICATION

This application is a continuation of International Patent Application No. PCT/JP2017/018348, having an international filing date of May 16, 2017, which designated the United States, the entirety of which is incorporated herein by reference.

### BACKGROUND

Conventionally, a method for acquiring distance information indicating a distance to a target object (in a narrow sense, a subject) has been used in various devices. For example, distance information is used in imaging devices performing auto-focus (AF) control, imaging devices handling three-dimensional images, or devices performing measurement and gaging.

As methods for acquiring the distance information, that is, as ranging methods, there are methods for ranging by detecting a phase difference from a plurality of images with parallax by a mechanism that divides an optical pupil. Specifically, there are known a method by which to perform pupil division at a lens position of an imaging device, a method by which to perform pupil division at a microlens position in a pixel of an image sensor, a method by which to perform pupil division by a dedicated detection element, and others.

JP-A-2013-3159 discloses a method by which a filter is formed between an optical system and an image sensor in an imaging device and the filter is configured in a switchable manner According to the technique disclosed in JP-A-2013-3159, the filter is switched to create states different in transmission band and detect a phase difference.

JP-A-2013-171129 discloses a method by which to perform pupil division and devising the transmission band of a pupil division filter, thereby estimating five band signals (multiband estimation).

### SUMMARY

In accordance with one of some embodiments, there is provided an imaging device comprising:

an optical filter that divides a pupil of an imaging optical system into a first pupil that transmits visible light and a second pupil that transmits invisible light;

an image sensor that is sensitive to the visible light and the invisible light; and

a processor including hardware,

the processor being configured to

generate a first pupil image as an image of the visible light and a second pupil image as an image of the invisible light based on an image captured by the image sensor, and detect a phase difference between the first pupil image and the second pupil image.

In accordance with one of some embodiments, there is provided an imaging device comprising:

an optical filter that divides a pupil of an imaging optical system into a first pupil and a second pupil different in transmission wavelength band of light;

an image sensor in which a first filter transmitting light in the transmission wavelength band of the first pupil and a second filter transmitting light in the transmission wavelength band of the second pupil are arranged two-dimensionally; and

a first light source that emits the light in the transmission wavelength band of the first pupil and a second light source that emits the light in the transmission wavelength band of the second pupil, wherein

the first light source and the second light source emit light in a time-division manner, and

a phase difference between an image generated based on light incident on the first filter at the time of emission from the first light source and an image generated based on light incident on the second filter at the time of emission from the second light source is detected.

In accordance with one of some embodiments, there is provided an imaging method comprising:

based on light having passed through an optical filter that divides a pupil of an imaging optical system into a first pupil that transmits visible light and a second pupil that transmits invisible light,

generating a first pupil image as an image of the visible light;

generating a second pupil image as an image of the invisible light; and

detecting a phase difference between the first pupil image and the second pupil image.

In accordance with one of some embodiments, there is provided an imaging method using an imaging optical system that has an optical filter to divide a pupil of the imaging optical system into a first pupil and a second pupil different in transmission wavelength band of light, wherein

the imaging method comprises:

causing a first light source to emit light in the transmission wavelength band of the first pupil and a second light source to emit light in the transmission wavelength band of the second pupil in a time-division manner;

generating a first pupil image based on light incident on a first filter transmitting the light in the transmission wavelength band of the first pupil in the image sensor at the time of emission from the first light source;

generating a second pupil image based on light incident on the second filter that transmits the light in the transmission wavelength band of the second pupil in the image sensor at the time of emission from the second light source; and

detecting a phase difference between the first pupil image and the second pupil image.

In accordance with one of some embodiments, there is provided an information storage device that stores a program for causing a computer to execute a process of a signal based on light having passed through an optical filter to divide a pupil of an imaging optical system into a first pupil and a second pupil different in transmission wavelength band of light,

the program causing the computer to execute the steps of:

causing a first light source to emit light in the transmission wavelength band of the first pupil and a second light source to emit light in the transmission wavelength band of the second pupil in a time-division manner;

generating a first pupil image based on light incident on a first filter transmitting the light in the transmission wavelength band of the first pupil in the image sensor at the time of emission from the first light source;

generating a second pupil image based on light incident on the second filter that transmits the light in the transmission wavelength band of the second pupil in the image sensor at the time of emission from the second light source; and detecting a phase difference between the first pupil image and the second pupil image.

### BRIEF DESCRIPTION OF THE DRAWINGS

FIG. 1 is a diagram illustrating a configuration example of an imaging device.

FIG. 2 is a diagram illustrating a basic configuration example of an imaging optical system.

FIG. 3 is a diagram illustrating a configuration example of an image sensor.

FIG. 4 is a diagram illustrating spectral characteristics of a light source, an optical filter, and the image sensor.

FIG. 5 is a diagram illustrating an example of response characteristics of the image sensor and captured images.

FIG. 6 is a diagram illustrating a generation example of image data based on a first captured image.

FIG. 7 is a diagram illustrating a generation example of image data based on a second captured image.

FIG. 8 is a time chart illustrating a phase difference detection process.

FIG. 9 is a flowchart illustrating the phase difference detection process.

FIG. 10 is a diagram illustrating another generation example of image data based on the second captured image.

FIGS. 11A and 11B are diagrams illustrating other configuration examples of an image sensor.

FIG. 12 is a time chart illustrating a live view mode.

FIG. 13 is a flowchart illustrating the live view mode.

FIG. 14 is a diagram illustrating a detailed configuration example of the imaging device.

FIG. 15 is a diagram illustrating a distance measurement method based on phase difference.

FIG. 16 is a diagram illustrating another detailed configuration example of an imaging device.

### DESCRIPTION OF EXEMPLARY EMBODIMENTS

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

Exemplary embodiments are described below. Note that the following exemplary embodiments do not in any way limit the scope of the content defined by the claims laid out herein. Note also that all of the elements described in the present embodiment should not necessarily be taken as essential elements.

1. System Configuration Example

As a phase difference detection method prior to JP-A-2013-3159, there is known a method by which to use ordinary three primary color image sensors to produce parallax between an image of a given color and images of other colors. For example, in the case where a right pupil transmits R and G and a left pupil transmits G and B, among captured RGB images, a phase difference between the R image (right pupil image) and the B image (left pupil image) with parallax is detected. In this example, since the phase difference between the R image and the B image is detected, there occurs a color deviation due to the phase difference. This causes a problem that it is difficult to achieve both the phase difference detection and the live view.

JP-A-2013-3159 and JP-A-2013-171129 propose methods for achieving both the phase difference detection and the live view. However, according to the technique disclosed in JP-A-2013-3159, it is necessary to provide a mechanism for switching between the insertion of an optical filter into an optical path and the retraction of the optical filter from the optical path. In addition, according to the technique disclosed in JP-A-2013-171129, it is necessary to properly set the transmission band of the optical filter to enable multiband estimation. Accordingly, special configurations are required for both the techniques disclosed in JP-A-2013-3159 and JP-A-2013-171129, which still have problems to be solved in terms of miniaturization and cost reduction.

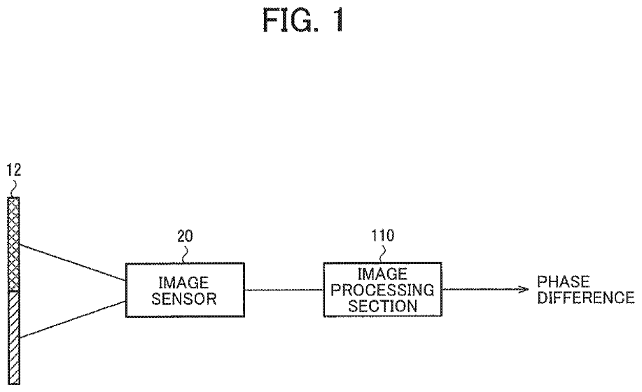

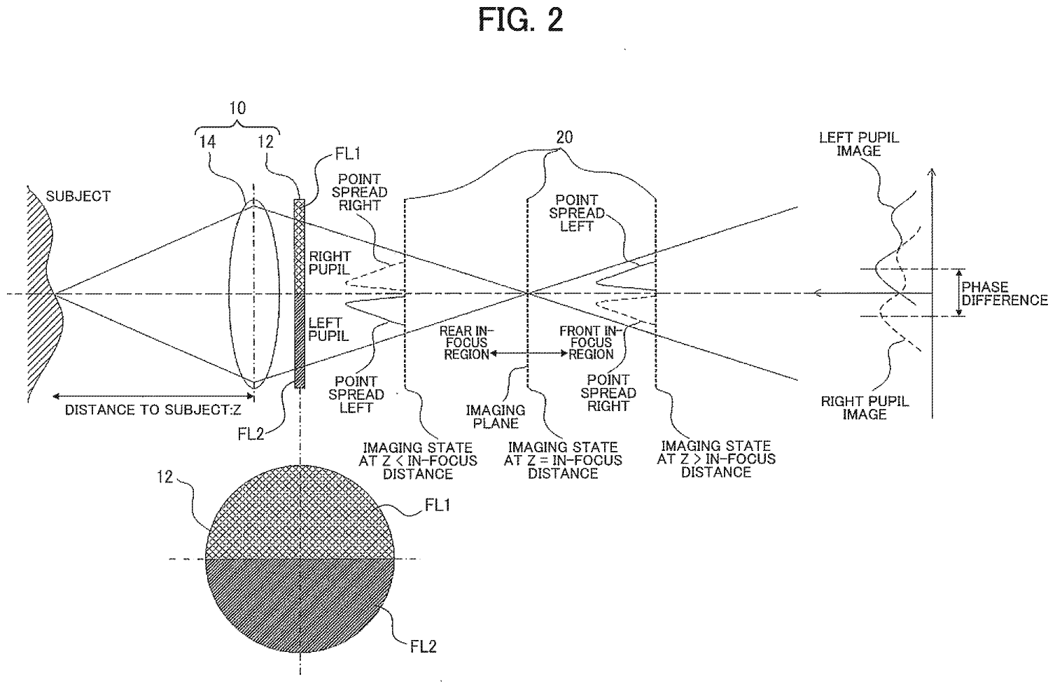

In contrast to this, according to the present embodiment, among the plurality of pupils having undergone pupil division, visible light is assigned to a given pupil and invisible light is assigned to the other pupil. Specifically, as illustrated in FIGS. 1 and 2, the imaging device according to the present embodiment includes: an optical filter 12 that divides a pupil of an imaging optical system 10 into a first pupil that transmits visible light and a second pupil that transmits invisible light; an image sensor 20 that is sensitive to the visible light and the invisible light; and an image processing section 110 that generates a first pupil image as an image of the visible light and a second pupil image as an image of the invisible light based on an image captured by the image sensor 20, and detects a phase difference between the first pupil image and the second pupil image.

According to the method in the present embodiment, the imaging device (the image processing section 110) detects the phase difference between the first pupil image as the image of the visible light and the second pupil image as the image of the invisible light. If there is an overlap in wavelength band between the two pupil images for phase difference detection, the separability of the pupil images becomes lower to reduce the accuracy of the phase difference detection. In this respect, according to the method in the present embodiment, the visible light image and the invisible light image are used to improve the separability of the pupil images and increase the accuracy of the phase difference detection because there is no overlap in the wavelength band unlike in a case where phase difference detection is performed between images of visible light (for example, an R image and a B image).

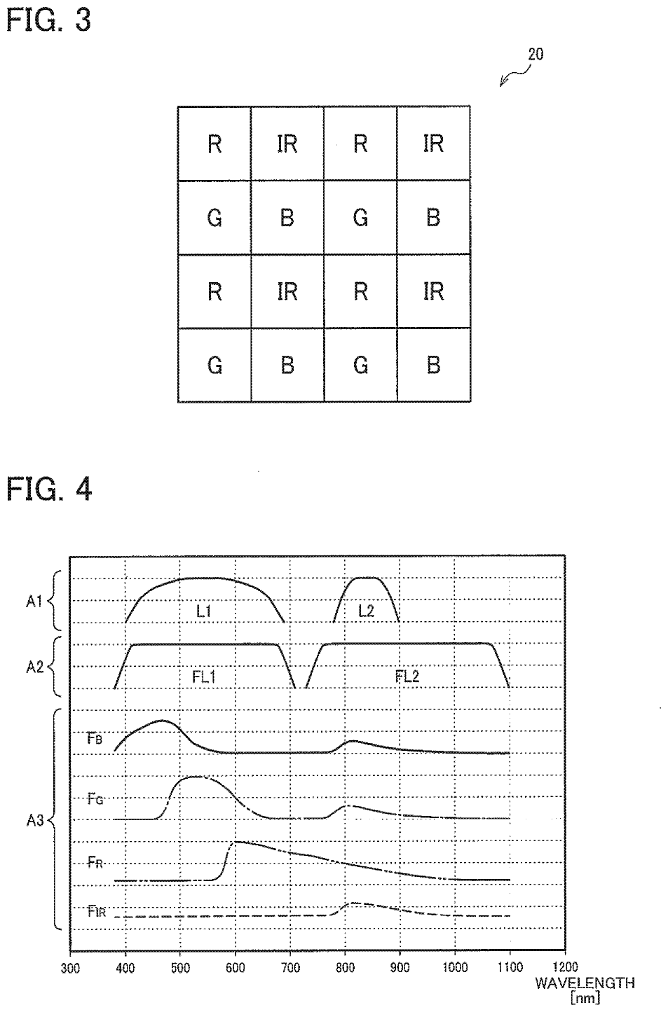

In addition, according to the method in the present embodiment, all kinds of light constituting the visible light (for example, red light, green light, and blue light) pass through the first pupil and are applied to the image sensor 20. There occurs no color deviation among R image data, G image data, and B image data for use in the generation of the display image (live view), which makes it possible to achieve both the phase difference detection and the live view. In this case, there is no need for a retraction mechanism (switching mechanism) as described in JP-A-2013-3159, which facilitates the miniaturization of the device. Further, in the present embodiment, there is no time lag due to the operation of a retraction mechanism, which makes it possible to improve real-time properties of the phase difference detection without the need to take into consideration a failure such as breakdown of a retraction mechanism. The optical filter 12 needs to include only two filters, that is, a filter that transmits the visible light and a filter that transmits the invisible light. The image sensor 20 can have a widely known configuration (for example, see FIG. 3). Accordingly, there is no need to use an optical system of a complex structure as described in JP-A-2013-171129, thereby achieving cost reduction as well.

Furthermore, in the present embodiment, the image of the invisible light image can also be used as the display image. This produces an advantage that the display image is switchable according to the situation.

FIG. 2 illustrates a basic configuration example of the imaging optical system 10 in the imaging device. The imaging device includes the imaging optical system 10 that forms an image of a subject on an imaging sensor (the image sensor 20). The imaging optical system 10 has an imaging lens 14 and the optical filter 12 for pupil dividing. The optical filter 12 has a first pupil filter FL1 (right pupil filter) with a first transmittance characteristic and a second pupil filter FL2 (left pupil filter) with a second transmittance characteristic. The optical filter 12 is provided at a pupil position in the imaging optical system 10 (for example, an installation position of a diaphragm), and the pupil filters FL1 and FL2 correspond respectively to the right pupil and the left pupil.

As illustrated in FIG. 2, a positional relationship between point spread in a case where light from a point light source passes through the right pupil and point spread in a case where light from the same point light source passes through the left pupil changes according to a relationship between a distance Z from the imaging optical system 10 to the subject and an in-focus distance (a distance to an object in an in-focus state at an in-focus object plane position). Accordingly, the image processing section 110 generates the first pupil image (the right pupil image) and the second pupil image (the left pupil image) and determines a phase difference through a comparison between image signals as illustrated in FIG. 2.

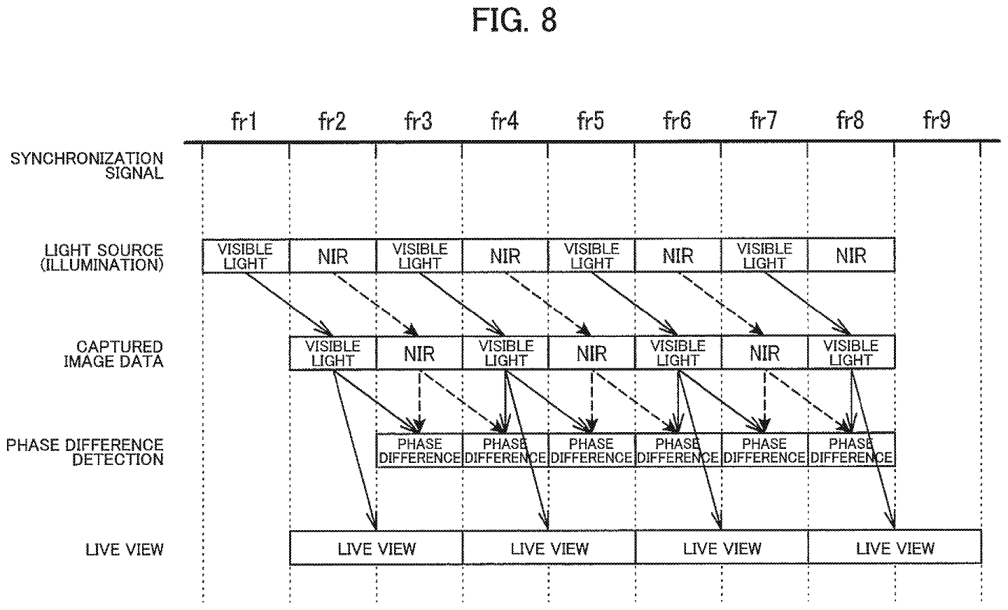

The optical filter 12 in the present embodiment is not limited to the configuration illustrated in FIG. 2 as far as the optical filter 12 can divide the pupil of the imaging optical system 10 into the first pupil transmitting the visible light and the second pupil transmitting the invisible light. For example, as illustrated in FIGS. 8 to 10 of JP-A-2013-3159, the optical filter 12 may have three or more filters different in transmittance characteristics.

FIG. 3 illustrates a configuration example of the image sensor 20. As illustrated in FIG. 3, for example, the image sensor 20 is an element that is formed by a pixel array in which, among minimum units of a color imaging sensor with Bayer array (four pixels of one R pixel, one B pixel, and two G pixels), one G pixel is replaced with an IR pixel. However, the image sensor 20 can be modified in various manner in the specific element array as far as the image sensor 20 is sensitive to the visible light and the invisible light.

FIG. 4 illustrates specific examples of spectral characteristics (A1) of first light and second light emitted from a light source section 30, spectral characteristics (A2) of the optical filter 12, and spectral characteristics (A3) of the image sensor 20. In FIG. 4, the horizontal axis indicates light wavelengths. The spectral characteristics illustrated in FIG. 4 are mere examples, and the upper and lower limits of the wavelength band (transmission wavelength band) or the transmittance at each wavelength can be modified in various manners.

As illustrated with A1 in FIG. 4, the light source section 30 emits the visible light as the first light (L1) and emits the invisible light as the second light (L2). The second light may be either ultraviolet light or infrared light. In the example described here, the second light is near infrared light.

As illustrated with A2 in FIG. 4, the first pupil filter FL1 of the optical filter 12 transmits the visible light, and the second pupil filter FL2 transmits the invisible light.

The image sensor 20 is provided with color filters (on-chip color filters) transmitting light in the wavelength band corresponding to each pixel, for example. Hereinafter, the color filter corresponding to the R pixel will be represented as F_{R}, the color filter corresponding to the G pixel will be represented as F_{G}, the color filter corresponding to the B pixel will be represented as F_{B}, and the color filter corresponding to the IR pixel will be represented as F_{IR}.

As illustrated with A3 in FIG. 4, the color filter F_{B} corresponding to the B pixel transmits the light in the wavelength band corresponding to blue light, the color filter F_{G} corresponding to the G pixel transmits the light in the wavelength band corresponding to green light, and the color filter F_{R} corresponding to the R pixel transmits the light in the wavelength band corresponding to red light. As illustrated with A3, the pixels may have the wavelength bands overlapping with each other. For example, the light in a given wavelength band passes through both the color filters F_{B} and F_{G}. The color filter F_{IR} corresponding to the IR pixel transmits the light in the wavelength band corresponding to near infrared light.

As the spectral characteristics of each pixel of the image sensor 20, the spectral characteristics of the color filters provided in the image sensor 20 have been described so far. However, the spectral characteristics of the image sensor 20 may include the spectral characteristics of members constituting the sensor (for example, silicon).

2. Phase Difference Detection

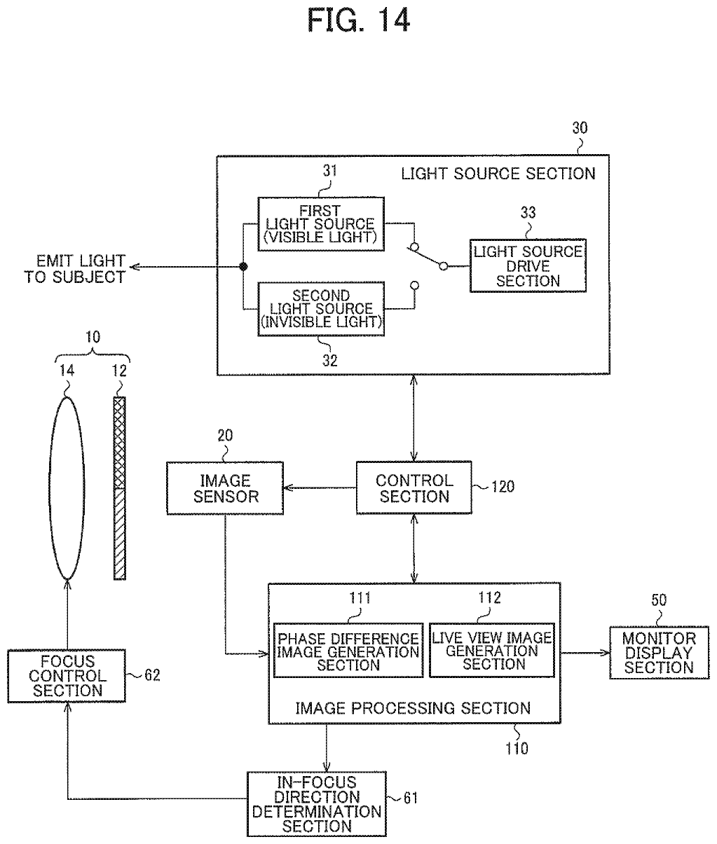

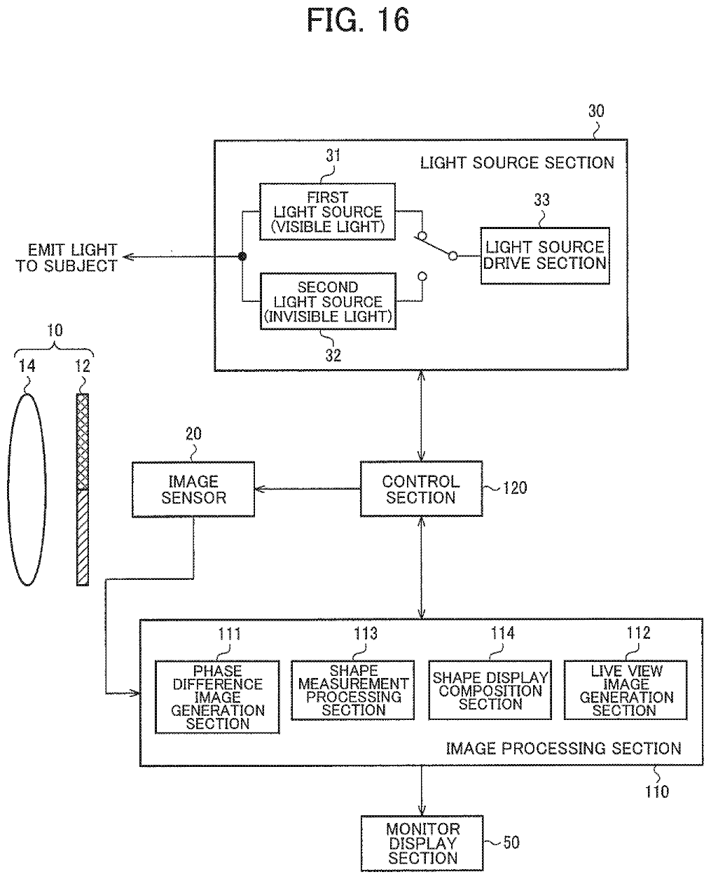

Next, a specific method for detecting the phase difference between the first pupil image and the second pupil image will be described. The imaging device in the present embodiment may include the light source section 30 that emits the first light in the wavelength band corresponding to the visible light and the second light in the wavelength band corresponding to the invisible light in a time-division manner (see FIGS. 14 and 16). The image sensor 20 captures a first captured image at the time of emission of the first light and a second captured image at the time of emission of the second light in a time-division manner. The image processing section 110 generates the first pupil image based on the first captured image and generates the second pupil image based on the second captured image.

In this manner, the light source section 30 emits the first light (the visible light) and the second light (the invisible light) in a time-division manner, thereby making it possible to increase the accuracy of the phase difference detection. As illustrated with A3 in FIG. 4, in some of widely used image sensors 20, the color filters F_{R}, F_{G}, and F_{B} corresponding to the RGB pixels cannot spectrally divide near infrared light. In other words, in some of the image sensors 20, all the color filters F_{R}, F_{G}, and F_{B} have characteristics of transmitting near infrared light. In this case, the RGB pixels used for the generation of the visible light image (the first pupil image) are sensitive to the invisible light as the light from the second pupil, which may decrease the separability of the pupil images depending on the settings of the emission light. In this respect, emitting the first light and the second light in a time-division manner makes it possible to suppress the component of the invisible light (the light having passed through the second pupil) from being included in the first pupil image.

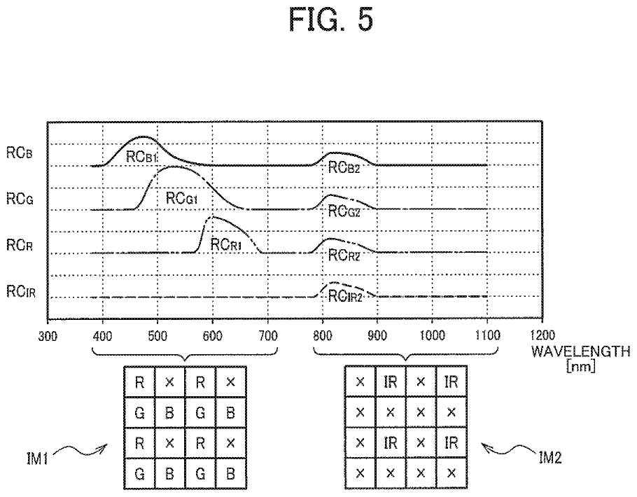

FIG. 5 illustrates an example of response characteristics (RC_{B}, RC_{G}, RC_{E}, and RC_{IR}) of the pixels of the image sensor 20, and the first captured image (IM1) and the second captured image (IM2) captured based on the characteristics. In FIG. 5, the horizontal axis indicates light wavelengths as in FIG. 4. The first and second captured images are based on the element array described above with reference to FIG. 3, and therefore it is obvious that the captured images will be different with different element arrays.

At the B pixel of the image sensor 20, the first light having passed through the first pupil filter FL1 and the color filter F_{B} corresponding to the B pixels is detected. In addition, at the B pixel, the second light having passed through the second pupil filter FL2 and the color filter F_{B} is detected. That is, the response characteristics RC_{B} of the B pixel are determined by a response characteristic (RC_{B1}) based on L1, FL1, and F_{B} illustrated in FIG. 4, and a response characteristic (RC_{B2}) based on L2, FL2, and F_{B} illustrated in FIG. 4.

Similarly, the response characteristics RC_{G} of the G pixel are determined by a response characteristic (RC_{G1}) based on L1, FL1, and F_{G}, and a response characteristic (RC_{G2}) based on L2, FL2, and F_{G}. Similarly, the response characteristics RC_{R} of the R pixel are determined by a response characteristic (RC_{R1}) based on L1, FL1, and F_{R}, and a response characteristic (RC_{B2}) based on L2, FL2, and F_{R}.

As for the IR pixel, the color filter F_{IR} does not transmit the light in the wavelength band corresponding to L1 (FL1), and thus a response characteristic RC₁ is determined in consideration of a response characteristic (RC_{IR2}) based on L2, FL2, and F_{IR}.

For the first captured image, the response to the first light among the response characteristics RC_{B}, RC_{G}, RC_{R}, and RC_{IR} illustrated in FIG. 5 is considered. Therefore, as illustrated with IM1 in FIG. 5, for the RGB pixels, signals (R, G, and B) are acquired corresponding to RC_{R1}, RC_{G1}, and RC_{B1}. On the other hand, the IR pixel is not sensitive to the first light, and thus the signal of the IR pixel is not used for the first captured image IM1 (represented as x).

For the second captured image, considering that the RGB pixels are pixels intended for detection of the visible light, the response of the IR pixel to the second light is simply considered as illustrated in FIG. 5. Specifically, for the second captured image IM2, the signal (IR) corresponding to the response characteristics RC_{IR2} is used, but the signals of the RGB pixels corresponding to the visible light are not used (represented as x).

In the example of FIGS. 4 and 5, however, as illustrated in the response characteristics RC_{B2}, RC_{G2}, and RC_{R2}, the RGB pixels are sensitive to the invisible light and are capable of detecting signals (IRr, IRg, and IRb) to the emission of the second light. Accordingly, the image processing section 110 can be modified to actively use the signals of the RGB pixels (IRr, IRg, and IRb) corresponding to the second light. The modification will be described later in detail.

As described above, the first captured image and the second captured image are acquired according to the respective emissions of the first light and the second light. However, as illustrated in FIG. 5, the respective signals of the pixels (R, G, B, and IR) are acquired for one of the four pixels and there are no signals of the colors (wavelength bands) corresponding to the other pixels. Accordingly, the image processing section 110 generates R image data, G image data, and B image data from the first captured image, and generates IR image data from the second captured image.

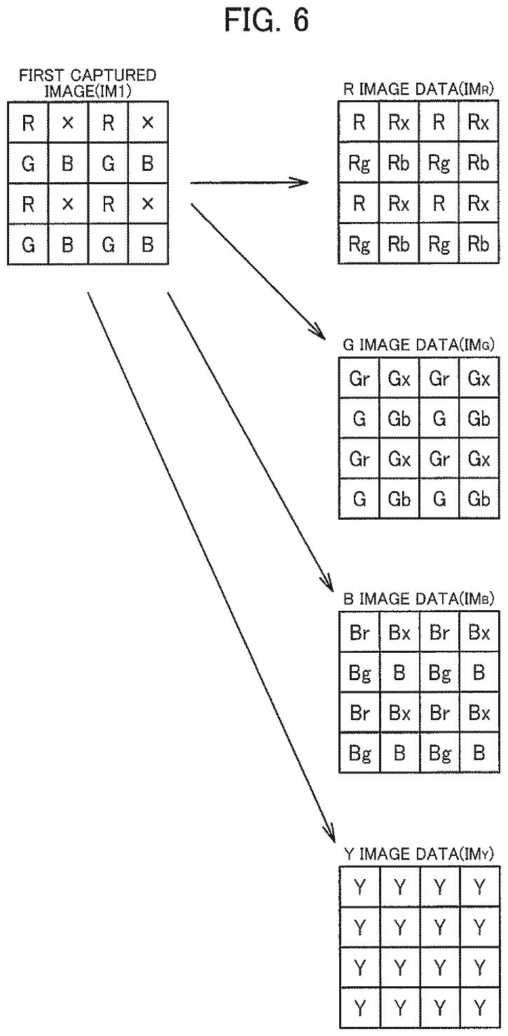

FIG. 6 is a diagram illustrating a method for generating the R image data (IM_{R}), the G image data (IM_{G}), and the B image data (IM_{B}) from the first captured image (IM1). As illustrated in FIG. 6, in the R image data, based on the originally acquired signal (R) corresponding to the red light, signals (Rg, Rb, and Rx) corresponding to the red light are interpolated at respective positions of the G, B, and IR pixels. This process is the same as the process executed in demosaicing (synchronization processing) and thus detailed description thereof will be omitted. The same thing is also applied to the G image data and the B image data. The G image data is generated by interpolating Gr, Gb, and Gx from the surrounding G signal. The B image data is generated by interpolating Br, Bg, and Bx from the surrounding B signal.

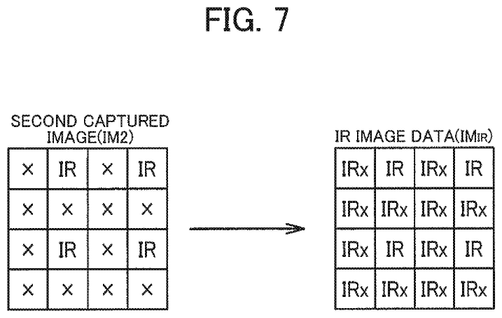

FIG. 7 is a diagram illustrating a method for generating the IR image data (IM_{IR}) from the second captured image (IM2). The same thing is also applied to the IR image data. Based on the originally acquired signal (IR) corresponding to the near infrared light, signals (IRx) corresponding to the near infrared light are interpolated at respective positions of the R, G, and B pixels.

FIG. 8 is a time chart describing a process of the present embodiment. In FIG. 8, the horizontal axis indicates time, and the input timing of a synchronization signal (input terminal) is set to one frame. As illustrated in FIG. 8, the light source section 30 emits the visible light in a first frame fr1. Together with the end of the emission of the visible light, the capturing of the first captured image by the image sensor 20 is completed. After that, the R image data, the G image data, and the B image data are generated by the image processing section 110. That is, the captured image data corresponding to the emission light in the frame fr1 is generated in a second frame fr2 as the next frame.

In the second frame fr2, the light source section 30 emits the invisible light, and the captured image data corresponding to the light emission (the second captured image, the IR image data) is generated in a third frame fr3. In FIG. 8, the emission of the invisible light and the generation of the captured image data by the light emission is expressed as NIR on the assumption that near infrared light (NIR) is used. This is also applicable to the subsequent frames. In the example of FIG. 8, the visible light and the invisible light are alternately emitted in a time-division manner, and the captured image data corresponding to the respective kinds of the emitted light are alternately generated in a time-division manner.

In the present embodiment, the phase difference between the first pupil image and the second pupil image is detected. That is, the detection of the phase difference requires the captured image data acquired by the emission of the visible light and the captured image data acquired by the emission of the invisible light. Thus, in the third frame fr3, the image processing section 110 performs phase difference detection using the captured image data in the frame fr2 and the captured image data in the frame fr3. In a fourth frame fr4, the image processing section 110 also performs phase difference detection using the captured image data in the frame fr3 and the captured image data in the frame fr4. The image processing section 110 can perform phase difference detection in each frame by repeating the foregoing process in the same manner.

As illustrated in FIG. 6, the three images of the R image data (IM_{R}), the B image data (IM_{B}), and the G image data (IM_{G}) are acquired from the first captured image (IM1) captured by the emission of the visible light. The three images are all generated based on the light having passed through the first pupil (the first light), and are usable as the first pupil images as targets of the phase difference detection. Furthermore, as illustrated in FIG. 6, the image processing section 110 can generate Y image data (luminance image data IM_{Y}) based on the R image data, the B image data, and the G image data. The calculation for determining a Y signal is widely known and thus description thereof will be omitted. The Y image data is also usable as the first pupil image.

Accordingly, in the present embodiment, the image sensor 20 in the imaging device includes first to N-th (N is an integer of 2 or larger) color filters to transmit the light corresponding to the wavelength band of the visible light, and the image processing section 110 generates first to N-th color images based on the light having passed through the first to N-th color filters at the time of emission of the first light. Then, the image processing section 110 selects one of the first to N-th color images and an image generated based on at least one of the first to N-th color images, and detects a phase difference between the selected image as the first pupil image and the second pupil image.

In this case, N indicates the number of the color filters, which is N=3 (R, G, and B) in the foregoing example. The first filters refer to the color filters of the image sensor 20, which are F_{R}, F_{G}, and F_{B} corresponding to R, G, and B. The first to N-th color images correspond to the R image data, the G image data, and the B image data. The image generated based on at least one of the first to N-th color images corresponds to the Y image data generated based on the three image data of R, G, and B, for example.

However, the image generated based on at least one of the first to N-th color images is not limited to the Y image data but may be image data obtained by combining the signals of the two image data among the R image data, the G image data, and the B image data. For example, the G image data and the B image data may be used to generate the image data corresponding to cyan, or similarly, the image data corresponding to magenta or yellow may be generated and set as a candidate for the first pupil image. In addition, the method for generating an image based on the first to N-th color images, for example, the combination ratio of image signals can be modified in various manners.

As illustrated in FIG. 11B referred to later, when the image sensor 20 of complementary colors is to be used, N=4 (Cy, Mg, Ye, and G), and the color images are four of Cy image data, Mg image data, Ye image data, and G image data. The image processing section 110 may generate the R image data and the B image data by combining two or more of the four image data, or may generate the Y image data in the same manner as described above. In this manner, the image used as the first pupil image can be modified in various manners.

As illustrated in FIG. 2, the phase difference is detected by determining with what degree of displacement (parallax) the same subject is captured between the first pupil image and the second pupil image. Thus, in consideration of the detection accuracy of the phase difference, it is important that the image to be the first pupil image is generated from a significant signal (reflecting the features of the subject) or highly correlates with the second pupil image as a comparison target.

Accordingly, the image processing section 110 detects the features of the subject based on the signal of light incident on the first filter (the signal corresponding to the visible light), and selects the first pupil image based on the detected features of the subject. This makes it possible to select appropriate image data as the first pupil image from among a plurality of image data that is acquirable from the first captured image, thereby enhancing the detection accuracy of the phase difference.

More specifically, the features of the subject include at least one of S/N information of the signal of light incident on the first filter, level information of the signal, and information on similarity between the signal and a signal corresponding to the second pupil image (the signal of light incident on the second filter of the image sensor 20). This allows the image processing section 110 to select the first pupil image by using the appropriate index value. The image processing section 110 may use any one of the foregoing kinds of information, or may use two or more of the foregoing kinds of information in combination.

The S/N information refers to information indicating the relationship between signal and noise, which is the S/N ratio in a narrow sense. The level information of the signal refers to information indicating the signal level, which is a statistical value such as the total value, average value, or mean value of the signal values (pixel values) in a narrow sense. When the S/N ratio is low (noise is relatively large) or the signal level is extremely low, the signal of light incident on the first filter does not reflect the characteristics (shape, edge, and others) of the subject and thus is determined as not suited for the detection of the phase difference.

The information on similarity with the signal corresponding to the second pupil image refers to information indicating to what degree the target image is similar to the IR image data, for example. The information on similarity is based on the sum of absolute difference (SAD) or the sum of squared difference (SSD) that is acquired at the execution of a matching process between images, for example, but may be based on any other information. The image data with low similarity is incapable of detecting a positional shift of the image signal at high accuracy, and thus is not suited for detection of the phase difference.

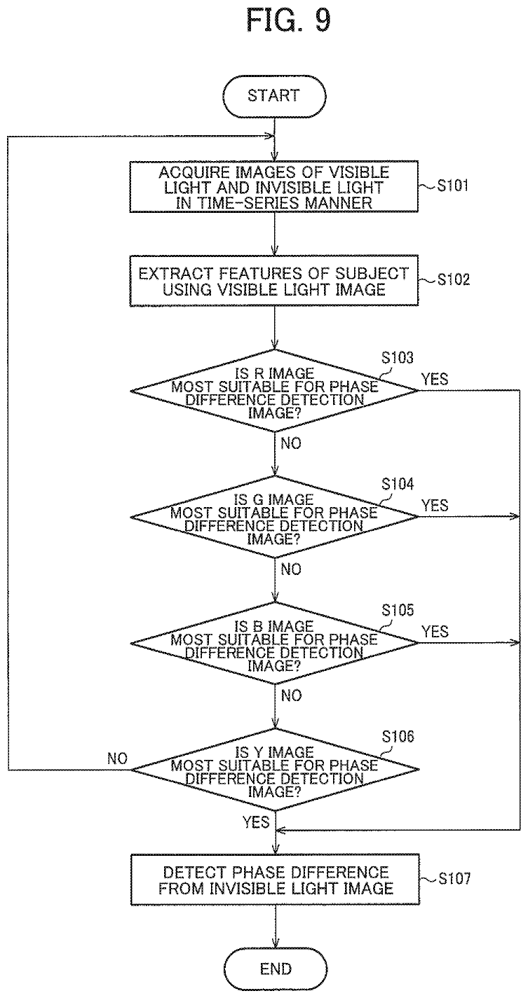

FIG. 9 is a flowchart of a phase difference detection process. When this process is started, the image processing section 110 acquires visible light images and an invisible light image in a time-series manner based on time-series emission of the visible light and the invisible light by the light source section 30 (S101). Next, the image processing section 110 extracts the features of the subject using the visible light images (S102). Then, based on the extracted features, the image processing section 110 determines which of the images of the R image data, the G image data, the B image data, and the Y image data to be suitable as the phase difference detection image (the first pupil image) (S103 to S106). In S103 to S106, the image processing section 110 may determine the features of the subject in all the plurality of visible light images (the R image data, the G image data, the B image data, and the Y image data) and compare the determined features to select the appropriate image as the first pupil image. Alternatively, the image processing section 110 may determine the features of the subject in a given visible light image, and compare the features with a given reference threshold value to determine whether the visible light image is appropriate as the first pupil image. In this case, when not determining that the given visible light image is appropriate as the first pupil image, the image processing section 110 performs the same process on another visible light image.

When determining that any of the images is appropriate (Yes in any of S103 to S106), the image processing section 110 detects the phase difference between the image determined as appropriate and the invisible light image (the IR image data) (S107), and terminates the process. The specific process of phase difference detection is widely known and thus detailed description thereof will be omitted. When not determining that there is no appropriate image (No in all S103 to S106), the image processing section 110 returns to S101 to acquire new images and attempt phase difference detection using the images.

In the example of AF described later with reference to FIG. 14, when the focus lens needs to be driven, for example, when a desired subject is out of focus, the image processing section 110 performs the process illustrated in FIG. 9. However, the image processing section 110 may not terminate the process by only one round of phase difference detection but may continue phase difference detection (after S107, returning to S101) as a modified embodiment. For example, in the case of executing continuous AF in moving images, the image processing section 110 may continue phase difference detection and continuously change the focus lens position.

3. Generation of Display Image

Next, a process of generating a display image will be described. The image sensor 20 includes the first filter that has a plurality of color filters (F_{R}, F_{G}, and F_{B}) to transmit light corresponding to the wavelength band of the visible light. At the time of emission of the first light (the visible light), the image sensor 20 captures the first captured image (IM1) based on the light incident on the plurality of color filters. The image processing section 110 generates a display image based on the first captured image.

That is, the imaging device of the present embodiment (the image processing section 110) generates a display image based on the visible light. As illustrated in FIG. 6, the first captured image (IM1) is lacking of data at pixel positions corresponding to the IR pixels. Accordingly, the image processing section 110 interpolates the G signal at the pixel positions corresponding to the IR pixels based on the data of the surrounding G pixels. Accordingly, the same image data as that of general Bayer array can be acquired, which makes it possible to generate a display image (color image) by a widely known demosaicing process. That is, the image processing section 110 can generate an image (3-plane image) in which each pixel has RGB pixel values. Alternatively, the image processing section 110 may generate the R image data (IM_{R}), the G image data (IM_{G}), and the B image data (IM_{B}) illustrated in FIG. 6, and combines these images to generate a display image.

The first captured image is an image captured based on the light from the first pupil, and thus the R image data, the G image data, and the B image data are all signals based on the light from the same pupil (the first pupil). Therefore, in the present embodiment, the occurrence of color deviation is suppressed so that it is possible to generate a highly visible display image without the need to make color deviation correction or the like.

As illustrated in the time chart of FIG. 8, the image processing section 110 generates a display image corresponding to the visible light in the second frame fr2 by the emission of the visible light in the first frame fr1. In addition, the image processing section 110 generates a next display image in the fourth frame fr4 by the emission of the visible light in the third frame fr3. For example, the display image generated in the second frame fr2 is used for display in the two frames fr2 and fr3, and the display image generated in the fourth frame fr4 is used for display in the two frames fr4 and fr5. This matter is applied to the subsequent frames. In the example of FIG. 8, the display image based on the visible light is updated in two frames each.

4. Modifications

The method for easily implementing both phase difference detection and live view using the visible light and the invisible light has been described so far. However, the method of the present embodiment is not limited to the foregoing one but can be modified in various manners.

4.1 Modification Related to Live View

In the example described above, the image (color image) corresponding to the visible light is used as a display image. In the present embodiment, however, the second pupil image can be acquired corresponding to the invisible light in phase difference detection. Thus, it is also possible to generate a display image corresponding to the invisible light.

Nevertheless, as illustrated in FIGS. 4 and 5, the image sensor 20 is less sensitive to the invisible light (near infrared light) than the wavelength band of the visible light, with a tendency to have a low resolution. As illustrated in FIG. 7, when the image (the IR image data IM_{IR}) in which the data at the R, G, and B pixel positions are interpolated from the IR pixel data is used as a display image, the display image is low in resolution and visibility of the subject, and thus is not suitable for display. Thus, in the case of setting the image based on the invisible light as a display image, it is desired to increase the resolution.

With consideration given to the foregoing matter, the image sensor 20 may include a second filter that transmits light corresponding to the wavelength band of the invisible light. At the time of emission of the second light, the image sensor 20 may capture the second captured image based on the light incident on the first filter and the second filter, and the image processing section 110 may generate a display image based on the second captured image.

In this case, the first filter has a plurality of color filters that transmit the light corresponding to the wavelength band of the visible light, which corresponds to F_{R}, F_{G}, and F_{B}, for example. The second filter corresponds to F_{IR}. To capture the second captured image, besides the light incident on the second filter, the light incident on the first filter is used. Specifically, as illustrated in FIGS. 4 and 5, taking advantage of the fact that F_{R}, F_{G}, and F_{B} transmit light in the wavelength band of the near infrared light, the signals acquired at the RGB pixels at the time of emission of the second light (the invisible light) are used for the second captured image.

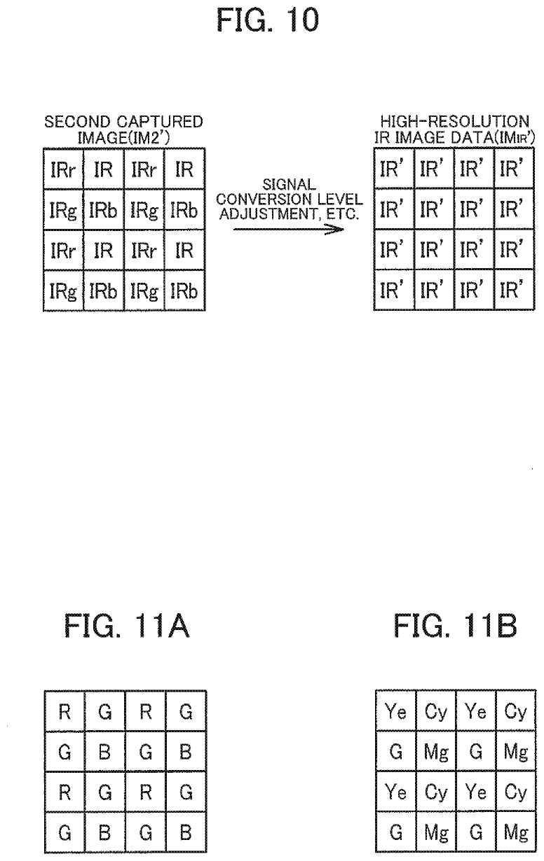

FIG. 10 is a diagram illustrating a process of generating the second captured image (IM2′) and IR image data (high-resolution IR image data, IM_{IR′}) based on the second captured image in the present modification. As illustrated in FIG. 10, in the present modification, at the time of emission of the invisible light, not only the signal of the IR pixel (IR) but also the signal of the R pixel (IRr), the signal of the G pixel (IRg), and the signal of the B pixel (IRb) are used. The signals IRr, IRg, and IRb respectively correspond to response characteristics shown as RC_{R2}, RC_{G2}, and RC_{B2} in FIG. 5.

As can be seen from comparison between the IM2′ illustrated in FIG. 10 and the IM2 illustrated in FIG. 7, in the second captured image of the present modification, the signals resulting from the emission of the invisible light can be acquired for all the pixels. This makes it possible to capture a high-resolution image as compared to the case of using only the signal of the IR pixel.

However, the RGB pixels are elements originally intended for outputting signals corresponding to the visible light (specifically, red light, green light, and blue light). Therefore, the sensitivities of the RGB pixels are set with reference to the visible light. Thus, the sensitivities of the RGB pixels to the invisible light (response characteristics) and the sensitivity of the IR pixel to the invisible light may not be equal. The sensitivity here refers to information indicating a relationship between the light intensity (the intensity of incident light on the element) and the output signal (pixel value).

Accordingly, as illustrated in FIG. 10, the image processing section 110 performs a signal level adjustment process on signals corresponding to the light incident on the first filter at the time of emission of the second light, and generates a display image based on the signal having undergone the signal level adjustment process and a signal corresponding to the light incident on the second filter at the time of emission of the second light.

The signals of the light incident on the first filter at the time of emission of the second light correspond to IRr, IRg, and IRb illustrated in FIG. 10. The signal of the light incident on the second filter at the time of emission of the second light corresponds to IR illustrated in FIG. 10. The image processing section 110 performs the signal level adjustment process on IRr, IRg, and IRb. Then, the image processing section 110 generates the high-resolution IR image data (IM_{IR′}) from the signal IR′ having undergone the signal level adjustment process and the signal IR of the IR pixel. The image processing section 110 generates a display image by performing a monochrome process on IM_{IR′} as a near infrared signal. In this case, it is only necessary to reduce the difference in signal level between IRr, IRg, IRb and IR, and thus the signal IR can be set as a target of the signal level adjustment process.

4.2 Modification Related to Configuration of Image Sensor

As described above, signals corresponding to the invisible light (near infrared light) can be detected at the RGB pixels. Accordingly, in the case of detecting the invisible light at the RGB pixels, it is possible to implement a modification in which no IR pixel is provided in the image sensor 20.

FIGS. 11A and 11B are diagrams illustrating a modification of the image sensor 20. As illustrated in FIG. 11A, the image sensor 20 may be an image sensor with widely known Bayer array. In this case, the image processing section 110 generates the first pupil image and the display image (color image) according to the emission of the visible light from the first pupil, and generates the second pupil image and the display image (monochrome image corresponding to the near infrared light) according to the emission of the invisible light from the second pupil.

However, in the case of using the image sensor 20 illustrated in FIG. 11A, it is not preferred that the visible light and the invisible light are emitted at the same time (for example, white light in the wide wavelength band or the like is emitted). This is because, when the visible light and the invisible light are emitted at the same time, the RGB pixels output signals based on both the light from the first pupil and the light from the second pupil, which would deteriorate the separability of the pupil and reduce the accuracy of the phase difference detection. For example, when the visible light and the invisible light are emitted at the same time, both the signal (R) corresponding to RC_{R1} and the signal (IRr) corresponding to RC_{R2} illustrated in FIG. 5 are detected at the R pixels. Thus, in the case of using the R image data as the first pupil image, the mixture of the signal IRr would cause deterioration of the pupil separability, whereas in the case of using the R image data as the second pupil image, the mixture of the signal R would cause deterioration of the pupil separability.

Thus, the image sensor 20 illustrated in FIG. 11A is preferably used in the case where the band separation of the illumination light has been done by the light source section 30 and the optical filter 12 (the pupil division filter). Specifically, as described above, the optical filter 12 is used to perform pupil division into the first pupil transmitting the visible light and the second pupil transmitting the invisible light, and then the light source section 30 performs the emission of the visible light and the emission of the invisible light in a time-division manner.

Alternatively, in the case where the band separation of the illumination light has been already done by the light source section 30 and the optical filter 12, the complementary color image sensor 20 illustrated in FIG. 11B can be used. Referring to FIG. 11B, Ye corresponds to yellow, Cy to cyan, Mg to magenta, and G to green. In the case of using such a widely known complementary color image sensor as well, it is possible to acquire the visible light image and the invisible light image, and detect a phase difference between these images.

4.3 Modification Related to Target Images of Phase Difference Detection

As a modification related to live view, an example of generating a display image using the high-resolution IR image data (IM_{IR′}) has been described above. The high-resolution IR image data is usable not only for a display image but also for phase difference detection, that is, is usable as the second pupil image.

The image sensor 20 of the present modification includes a first filter that transmits light corresponding to the wavelength band of visible light and the light corresponding to the invisible light (for example, a filter having a plurality of color filters F_{R}, F_{G}, and F_{B}) and a second filter that transmits light corresponding to the wavelength band of the invisible light (for example, F_{IR}). That is, the first filter has a characteristic of transmitting not only the visible light but also the invisible light. Specific examples are as described above with reference to FIGS. 4 and 5.

The image processing section 110 generates a first pupil image based on light incident on the first filter at the time of emission of the first light (the visible light), generates a second pupil image based on light incident on the first filter and the second filter at the time of emission of the second light (the invisible light), and detects a phase difference between the first pupil image and the second pupil image.

In this manner, the second pupil image (IM_{IR′}) is generated using signals (IRr, IRg, and IRb) based on the light incident on the first filter at the time of emission of the second light. Accordingly, the resolution of the second pupil image becomes higher than in the case of using the method illustrated in FIG. 7, which makes it possible to perform high-accuracy phase difference detection.

It is preferred to perform signal level adjustment between IRr, IRg, IRb and IR at the time of generation of the second pupil image in the same point as in the process of generating the display image. Accordingly, at the time of emission of the second light, the image processing section 110 performs a signal level adjustment process on the signals of the light incident on the first filter, and generates the second pupil image based on the signals having undergone the signal level adjustment process and the signal of the light incident on the second filter at the time of emission of the second light. This makes it possible to reduce differences in sensitivity between the pixels in the second pupil image and perform high-accuracy phase difference detection.

In addition, since the first pupil image and the second pupil image are compared in the phase difference detection, performing the signal level adjustment between the images further improves the accuracy of phase difference detection. The signal level adjustment can be implemented by image processing but may result in noise enhancement. Thus, in consideration of accuracy, the signal level adjustment between the images is preferably implemented by adjustment of the emission amounts of the first light and the second light.

Accordingly, the imaging device includes a control section 120 that controls the light source section 30. The control section 120 performs an adjustment control to adjust the emission amount of at least one of the first light and the second light from the light source section 30. The image processing section 110 detects a phase difference between the first pupil image and the second pupil image based on the emission of the first light and the second light after the adjustment control. The control of the control section 120 is performed based on statistical values of pixel values of the first pupil image and the second pupil image thus generated, for example. For example, the control section 120 controls the emission amount of at least one of the first light and the second light such that the statistical values of the pixel values become comparable with one another.

4.4 Modification Related to Operation Modes

The imaging device of the present embodiment is capable of detecting a phase difference but does not need to perform phase difference detection at any time. Therefore, the imaging device may have an operation mode in which to perform phase difference detection and an operation mode in which not to perform phase difference detection.

Specifically, the imaging device includes the control section 120 that performs a control of operation modes including an emission light switching mode and an emission light non-switching mode. In the emission light switching mode, the light source section 30 emits the first light and the second light in a time-division manner, and the image processing section 110 detects a phase difference between the first pupil image based on the emission of the first light and the second pupil image based on the emission of the second light. That is, the emission light switching mode can also be said to be a phase difference detection mode.

In the emission light non-switching mode, the light source section 30 emits one of the first light and the second light. The image processing section 110 generates a display image based on the emission of the first light at the time of emission of the first light, and generates a display image based on the emission of the second light at the time of emission of the second light. That is, the emission light non-switching mode can also be said to be a live view mode. The live view mode may have two modes: a visible light live view mode in which to generate a display image of the visible light (color image); and an invisible light live view mode in which to generate a display image of the invisible light (a monochrome image of near infrared light).

This makes it possible to switch as appropriate between execution and non-execution of phase difference detection. In the live view mode, the light source section 30 only needs to emit either one of the visible light and the invisible light for use in the generation of the display image, thereby omitting the emission of the other light.

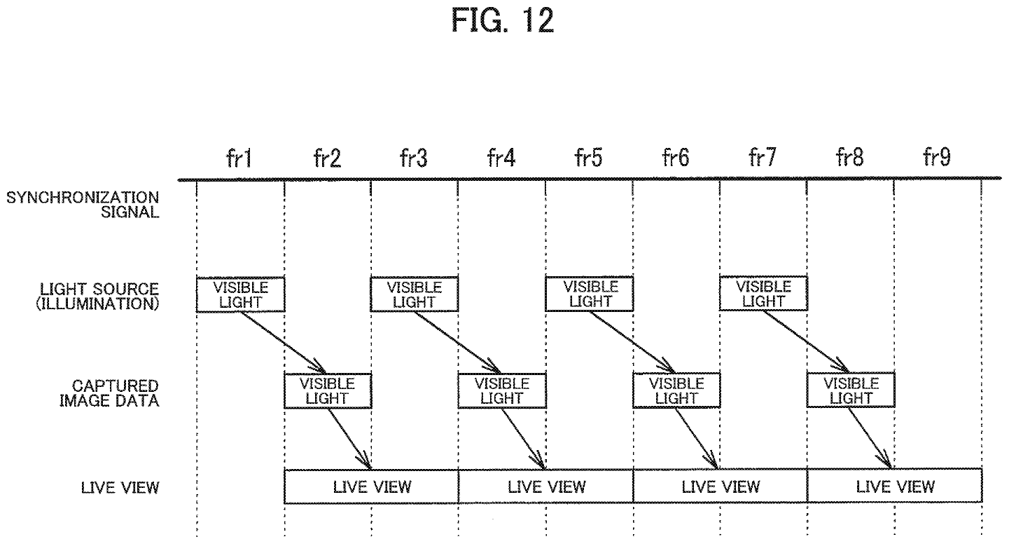

FIG. 12 illustrates an example of a time chart in the live view mode (in particular, the visible light live view mode). Synchronization signals (frames) are the same as those in the time chart illustrated in FIG. 8.

In the visible light live view mode, the light source section 30 emits the visible light but does not emit the invisible light. Accordingly, as compared to the case illustrated in FIG. 8, the emission of light in the even-numbered frames is omitted. In addition, the acquisition of captured image data is performed in the even-numbered frames, and thus the acquisition of captured image data in the preceding odd-numbered frames where no emission light is applied can be omitted.

FIG. 12 illustrates an example where the emission timings of the visible light (emission frames) are aligned with those illustrated in FIG. 8, and thus the emission of the visible light and the updating of the display image are performed once per two frames. However, as a modification, the emission of the visible light by the light source section 30 can be performed in every frame, and the acquisition of the captured image data and the updating of the display image can be performed in every frame. In this case, as compared to the example illustrated in FIG. 12, the frame rate of live view can be raised, though the power consumption in the light source section 30 and the processing load on the image processing section 110 increase. FIG. 12 illustrates an example in the visible light live view mode, but the invisible light live view mode can be considered in a similar manner.

In the emission light non-switching mode, the control section 120 may select which of a control to cause the light source section 30 to emit the first light and a control to cause the light source section 30 to emit the second light, based on the signal of the light incident on the first filter. In other words, the control section 120 determines whether to operate in the visible light live view mode or operate in the invisible light live view mode based on information on the RGB pixels (pixel values and others).

More specifically, the control section 120 selects the operation mode based on the signal of the light incident on the first filter at the time of emission of the first light (the visible light). In general, as compared to the display image using the invisible light (the monochrome image using the IR image data), the display image using the visible light (the color image) reproduces the colors of the subject and has excellent visibility with high resolution. Accordingly, when it is determined that the visible light image is suitable for observation of the subject, the control section 120 actively uses the visible light live view mode. On the other hand, when the visible light image includes large noise or when the pixel values are extremely low, the visible light image is not suitable for observation of the subject. In such a case, the control section 120 uses the invisible light live view mode.

The visible light image for use in the determination may be all the R image data, the G image data, and the B image data, or may be any one of them, or may be a combination of two of them. In addition, the Y image data can be used for the determination as a modification.

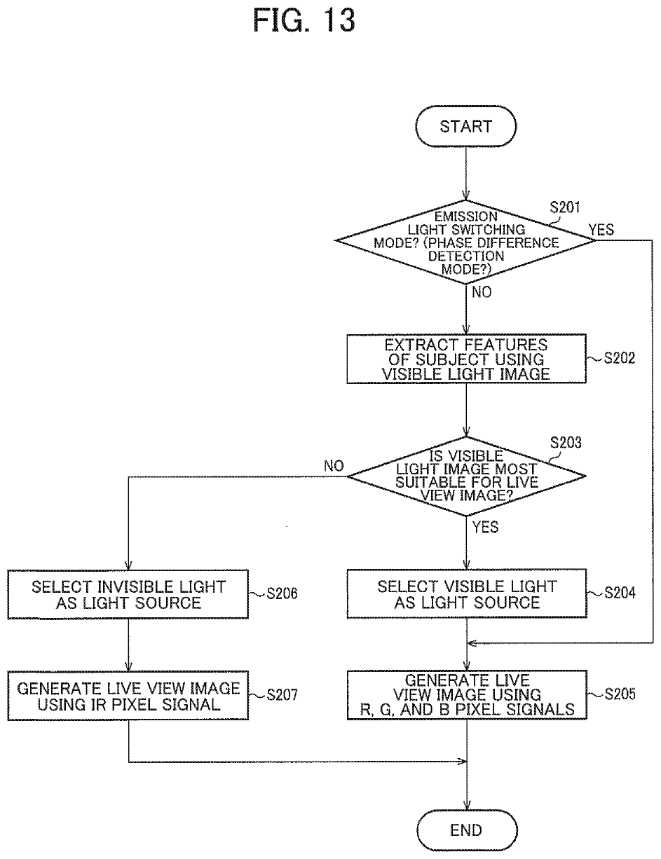

FIG. 13 is a flowchart of mode selection and a display image generation process in each mode. When this process is started, the control section 120 first determines whether to operate in the phase difference detection mode (the emission light switching mode) (S201). The determination in S201 is made based on the user's mode setting input, for example. When the phase difference detection mode is not set (No in S201), the image processing section 110 extracts the features of the subject using the visible light image (S202). The features of the subject here can be the S/N ratio or the signal level as in the example described above.

The control section 120 determines whether the visible light image is suitable as a live view image based on the extracted features of the subject (S203). For example, when the S/N ratio is equal to or greater than a predetermined threshold value, or the signal level is equal to or greater than a predetermined threshold value, or the both are satisfied, the control section 120 determines that the visible light image is suitable as a live view image.

When making a YES determination in S203, the control section 120 selects the visible light as a light source, and controls the light source section 30 to emit the visible light (S204). The image processing section 110 generates a display image based on the visible light emitted in S204 (S205).

When making a No determination in S203, the control section 120 selects the invisible light as a light source, and controls the light source section 30 to emit the invisible light (S206). The image processing section 110 generates a display image based on the invisible light emitted in S206 (S207).

When the phase difference detection mode is selected as an operation mode (Yes in S201), the first captured image and the first pupil image determined from the first captured image are expected to reflect the features of the subject to the degree that at least the phase difference can be detected. Thus, in the phase difference detection mode, a display image is generated using the visible light. Specifically, between the visible light and the invisible light emitted in a time-division manner, the image processing section 110 generates a display image based on the RGB signals acquired by the emission of the visible light (S205). However, FIG. 13 illustrates a mere example of the process. As a modification, a display image can be generated based on the invisible light in the phase difference detection mode.

5. Application Example

FIG. 14 illustrates an example of an imaging device in a case where the detected phase difference is used for AF. The imaging device includes the imaging lens 14, the optical filter 12, the image sensor 20, the image processing section 110, the control section 120, the light source section 30, a monitor display section 50, an in-focus direction determination section 61, and a focus control section 62.

The optical filter 12 and the image sensor 20 are as described above. The image processing section 110 includes a phase difference image generation section 111 and a live view image generation section 112. The phase difference image generation section 111 generates the first pupil image and the second pupil image based on the images captured by the image sensor 20, and detects the phase difference. The live view image generation section 112 generates a live view image (display image).

The control section 120 controls the operation mode and controls the light source section 30. The details of the controls are as described above.

The monitor display section 50 displays the display image generated by the live view image generation section 112. The monitor display section 50 can be implemented by a liquid crystal display or an organic EL display, for example.

The light source section 30 includes a first light source 31, a second light source 32, and a light source drive section 33. The first light source 31 is a light source that emits the visible light, and the second light source 32 is a light source that emits the invisible light (near infrared light). The light source drive section 33 drives either one of the first light source 31 and the second light source 32 under control of the control section 120. In the phase difference detection mode, the light source drive section 33 drives the first light source 31 and the second light source 32 in a time-series manner (alternately). In the live view mode, the light source drive section 33 drives either one of the first light source 31 and the second light source 32 continuously or intermittently.

The in-focus direction determination section 61 determines the in-focus direction based on the phase difference. The in-focus direction here refers to information indicating in which direction a desired subject is oriented with respect to the current in-focus object plane position (the position of the object in the in-focus state). Alternatively, the in-focus direction may refer to information indicating the driving direction of the imaging lens 14 (focus lens) for focusing on the desired subject.

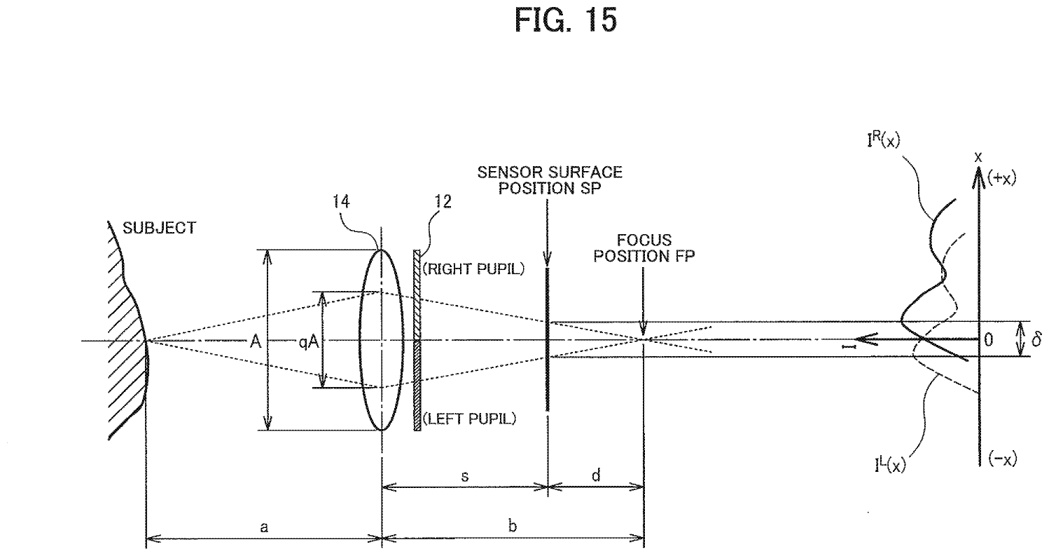

FIG. 15 is a diagram describing a method for estimating a distance to the subject based on the phase difference. As illustrated in FIG. 15, when an aperture of the diaphragm is designated as A, a distance between gravity centers of the right and left pupils with respect to the aperture A is designated as q×A, a distance from a center of the imaging lens 14 to a sensor surface PS of the image sensor 20 on an optical axis is designated as s, and a phase difference between a right pupil image IR(x) and a left pupil image IL(x) on the sensor surface PS is designated as δ, the following equation (1) holds by triangulation method:

q×A:δ=b:d,

b=s+d (1)

where q represents a coefficient satisfying 0<q≤1, q×A represents a value varying also depending on the aperture, s represents a value detected by the lens position detection sensor, b represents a distance from the center of the imaging lens 14 to a focus position PF on the optical axis, and δ is determined by correlation calculation. In the foregoing equation (1), a defocus amount d is given by the following equation (2):

d=(δ×s)/{(q×A)−δ} (2)

The distance a refers to a distance corresponding to the focus position PF, which ranges from the imaging lens 14 to the subject on the optical axis. In general, when a composite focal length in an imaging optical system formed from a plurality of lenses is designated as f, the following equation (3) holds:

(1/a)+(1/b)=1/f (3)

The value of b is determined by the following equation (1) from the defocus amount d and the detectable value s determined by the foregoing equation (2), and the value of b and the composite focal length f determined by the imaging optical configuration are substituted into the foregoing equation (3) to calculate the distance a.

Assuming that FIG. 15 is a diagram viewed from the top of the imaging device (from the direction perpendicular to the pupil division direction), for example, x represents a coordinate axis of the horizontal direction (the pupil division direction). When the phase difference 6 on the coordinate axis x is defined by a positive or negative sign with respect to either the right pupil image IR(x) or the left pupil image IL(x), the in-focus direction determination section 61 identifies from the positive or negative phase difference 6 whether the sensor surface PS is positioned in front of or behind the focus position PF. When the front-back positional relationship between the sensor surface PS and the focus position PF is known, it can be easily seen in which direction the focus lens is to be moved to align the sensor surface PS with the focus position PF.

The focus control section 62 drives the imaging lens 14 (the focus lens) such that the defocus amount d becomes zero for focusing.

Since the distance a can be calculated corresponding to an arbitrary pixel position by the foregoing equations (1) to (3), it is possible to measure the distance to the subject and measure the three-dimensional shape of the subject.

FIG. 16 illustrates an example of an imaging device to perform shape measurement. As compared to the example illustrated in FIG. 14, the in-focus direction determination section 61 and the focus control section 62 are eliminated, and a shape measurement processing section 113 and a shape display composition section 114 are added to the image processing section 110.

The shape measurement processing section 113 measures the three-dimensional shape of the subject according to the foregoing equations (1) to (3). The shape measurement processing section 113 may determine the distance a for pixels in a given region of an image, or may determine the distance a for all the pixels in the image. Alternatively, the shape measurement processing section 113 may accept an input of specifying two given points in the image from the user and determine a three-dimensional distance between the two points.

The shape display composition section 114 superimposes (composites) the information determined by the shape measurement processing section 113 on the live view image. For example, in an example in which the user specifies two points, the shape display composition section 114 superimposes the information indicating the points specified by the user and the information indicating a determined distance between the two points (for example, a numerical value) on the live view image. However, the information composited by the shape display composition section 114 can be implemented in various modifications. For example, the shape display composition section 114 may superimpose an image representing a three-dimensional map (depth map), or may superimpose information for enhancing the subject of a shape satisfying a predetermined condition.

The method according to the present embodiment is also applicable to an imaging device that includes: the optical filter 12 that divides a pupil of an imaging optical system into a first pupil and a second pupil different in transmission wavelength band of light; the image sensor 20 in which a first filter having a first transmittance characteristic of transmitting light in the transmission wavelength band of the first pupil and a second filter transmitting light in the transmission wavelength band of the second pupil are arranged two-dimensionally; the first light source 31 that emits the light in the transmission wavelength band of the first pupil; and the second light source 32 that emits the light in the transmission wavelength band of the second pupil. The imaging device causes the first light source 31 and the second light source 32 to alternately emit light in a time-division manner, and detects a phase difference between an image generated based on light incident on the first filter at the time of emission from the first light source 31 and an image generated based on light incident on the second filter at the time of emission from the second light source 32.

This makes it possible to detect the phase difference by operating the two light sources with the different wavelength bands of the emission light in a time-division manner and using the optical filter 12 (pupil division filter) in the wavelength bands corresponding to the two kinds of light. The time-division operation produces high pupil separability and enables high-accuracy phase difference detection as described above.

Some or most parts of the processes performed by the imaging device (in particular, the image processing section 110 and the control section 120) according to the present embodiment may be implemented by programs. In this case, the imaging device according to the present embodiment is implemented by a processor such as a CPU executing the programs. Specifically, the programs are read out from a (non-transient) information storage device, and the read programs are executed by the processor such as a CPU. The information storage device (computer-readable device or medium) stores a program and data. A function of the information storage device can be implemented with an optical disk (such as a digital versatile disk or a compact disk), a hard disk drive (HDD), or a memory (such as a card-type memory or a read only memory (ROM)). The processor such as a CPU performs various processes according to the present embodiment based on a program (data) stored in the information storage device. Thus, the information storage device stores a program (a program causing a computer to execute the processes of the components) causing a computer (a device including an operation section, a processing section, a storage section, and an output section) to function as components according to the present embodiment.

The imaging device according to the present embodiment (in particular, the image processing section 110 and the control section 120) may include a processor and a memory. For example, the processor may have functions of sections each implemented by individual hardware, or the functions of sections each implemented by integrated hardware. For example, the processor may include hardware, and the hardware may include at least one of a circuit that processes a digital signal and a circuit that processes an analog signal. For example, the processor may include one or a plurality of circuit devices (such as an integrated circuit (IC) for example) mounted on a circuit board, or one or a plurality of circuit elements (such as a resistor and a capacitor, for example). The processor may be a central processing unit (CPU), for example. Note that the processor is not limited to a CPU, but various other processors such as a graphics processing unit (GPU) or a digital signal processor (DSP) may also be used. The processor may be a hardware circuit that includes an ASIC. The processor may include an amplifier circuit, a filter circuit, and the like that process an analog signal. The memory may be a semiconductor memory (e.g., SRAM or DRAM), or may be a register. The memory may be a magnetic storage device such as a hard disk drive (HDD), or may be an optical storage device such as an optical disc device. For example, the memory stores a computer-readable instruction, and the process (function) of each section of the imaging device is implemented by causing the processor to perform the instruction. The instruction may be an instruction set that is included in a program, or may be an instruction that instructs the hardware circuit included in the processor to operate.

In accordance with one of some embodiments, there is provided an imaging device comprising:

an optical filter that divides a pupil of an imaging optical system into a first pupil that transmits visible light and a second pupil that transmits invisible light;

an image sensor that is sensitive to the visible light and the invisible light; and

a processor including hardware,

the processor being configured to

generate a first pupil image as an image of the visible light and a second pupil image as an image of the invisible light based on an image captured by the image sensor, and detect a phase difference between the first pupil image and the second pupil image.

In accordance with one of some embodiments, there is provided an imaging device comprising:

an optical filter that divides a pupil of an imaging optical system into a first pupil and a second pupil different in transmission wavelength band of light;

an image sensor in which a first filter transmitting light in the transmission wavelength band of the first pupil and a second filter transmitting light in the transmission wavelength band of the second pupil are arranged two-dimensionally; and

a first light source that emits the light in the transmission wavelength band of the first pupil and a second light source that emits the light in the transmission wavelength band of the second pupil, wherein

the first light source and the second light source emit light in a time-division manner, and

a phase difference between an image generated based on light incident on the first filter at the time of emission from the first light source and an image generated based on light incident on the second filter at the time of emission from the second light source is detected.

In accordance with one of some embodiments, there is provided an imaging method comprising:

based on light having passed through an optical filter that divides a pupil of an imaging optical system into a first pupil that transmits visible light and a second pupil that transmits invisible light,

generating a first pupil image as an image of the visible light;

generating a second pupil image as an image of the invisible light; and

detecting a phase difference between the first pupil image and the second pupil image.

In accordance with one of some embodiments, there is provided an imaging method using an imaging optical system that has an optical filter to divide a pupil of the imaging optical system into a first pupil and a second pupil different in transmission wavelength band of light, wherein

the imaging method comprises:

causing a first light source to emit light in the transmission wavelength band of the first pupil and a second light source to emit light in the transmission wavelength band of the second pupil in a time-division manner;

generating a first pupil image based on light incident on a first filter that transmits the light in the transmission wavelength band of the first pupil in the image sensor at the time of emission from the first light source;

generating a second pupil image based on light incident on the second filter that transmits the light in the transmission wavelength band of the second pupil in the image sensor at the time of emission from the second light source; and

detecting a phase difference between the first pupil image and the second pupil image.

In accordance with one of some embodiments, there is provided an information storage device that stores a program for causing a computer to execute a process of a signal based on light having passed through an optical filter to divide a pupil of an imaging optical system into a first pupil and a second pupil different in transmission wavelength band of light,

the program causing the computer to execute the steps of:

causing a first light source to emit light in the transmission wavelength band of the first pupil and a second light source to emit light in the transmission wavelength band of the second pupil in a time-division manner;

generating a first pupil image based on light incident on a first filter that transmits the light in the transmission wavelength band of the first pupil in the image sensor at the time of emission from the first light source;

generating a second pupil image based on light incident on the second filter that transmits the light in the transmission wavelength band of the second pupil in the image sensor at the time of emission from the second light source; and

detecting a phase difference between the first pupil image and the second pupil image.

Although the embodiments to which the present disclosure is applied and the modifications thereof have been described in detail above, the present disclosure is not limited to the embodiments and the modifications thereof, and various modifications and variations may be made without departing from the scope of the present disclosure. The plurality of elements disclosed in the embodiments and the modifications may be combined as appropriate. For example, some of all the elements described in the embodiments and the modifications may be deleted. Furthermore, elements in different embodiments and modifications may be combined as appropriate. Any term cited with a different term having a broader meaning or the same meaning at least once in the specification and the drawings can be replaced by the different term in any place in the specification and the drawings. Thus, various modification and application can be made without departing from the gist of the present disclosure.

What is claimed is:

1. An imaging device comprising:
an optical filter that divides a pupil of an imaging optical system into a first pupil that transmits visible light and a second pupil that transmits invisible light;
an image sensor that is sensitive to the visible light and the invisible light; and
a processor including hardware,
the processor being configured to
generate a first pupil image as an image of the visible light and a second pupil image as an image of the invisible light based on an image captured by the image sensor, and detect a phase difference between the first pupil image and the second pupil image.

2. The imaging device as defined in claim 1, further comprising
a light source that emits first light in a wavelength band corresponding to the visible light and second light in a wavelength band corresponding to the invisible light in a time-division manner, wherein
the image sensor captures a first captured image at the time of emission of the first light and a second captured image at the time of emission of the second light in a time-division manner, and
the processor generates the first pupil image based on the first captured image and generates the second pupil image based on the second captured image.

3. The imaging device as defined in claim 2, wherein
the image sensor includes a first filter that has a plurality of color filters to transmit light corresponding to the wavelength band of the visible light,
the image sensor captures the first captured image based on light incident on the plurality of color filters at the time of emission of the first light, and
the processor generates a display image based on the first captured image.

4. The imaging device as defined in claim 3, wherein
the image sensor includes a second filter that transmits light corresponding to the wavelength band of the invisible light,
the image sensor captures the second captured image based on light incident on the first filter and the second filter at the time of emission of the second light, and
the processor generates the display image based on the second captured image.

5. The imaging device as defined in claim 3, wherein
the processor performs a control of operation modes including an emission light switching mode and an emission light non-switching mode,
in the emission light switching mode,
the light source emits the first light and the second light in a time-division manner,
the processor detects the phase difference between the first pupil image based on the emission of the first light and the second pupil image based on the emission of the second light,
in the emission light non-switching mode,
the light source emits one of the first light and the second light, and
the processor generates the display image based on the emission of the first light at the time of emission of the first light, and generates the display image based on the emission of the second light at the time of emission of the second light.

6. The imaging device as defined in claim 5, wherein
the processor selects in the emission light non-switching mode which of a control to cause the light source to emit the first light and a control to cause the light source to emit the second light, based on a signal of light incident on the first filter.

7. The imaging device as defined in claim 1, wherein
the image sensor includes a first filter that has first to N-th (N is an integer of 2 or larger) color filters to transmit light corresponding to the wavelength band of the visible light,
the processor generates first to N-th color images based on light having passed through the first to N-th color filters at the time of emission of the first light, and
the processor selects one of the first to N-th color images and an image generated based on at least one of the first to N-th color images, and detects the phase difference between the selected image as the first pupil image and the second pupil image.

8. The imaging device as defined in claim 7, wherein
the processor detects features of the subject based on a signal of the light incident on the first filter, and select the first pupil image based on the detected features of the subject.

9. The imaging device as defined in claim 8, wherein
the features of the subject include at least one of S/N information of the signal, level information of the signal, and information on similarity between the signal and a signal corresponding to the second pupil image.

10. The imaging device as defined in claim 2, wherein
the image sensor includes a first filter that transmits light corresponding to the wavelength band of the visible light and light corresponding to the invisible light and a second filter that transmits light corresponding to the wavelength band of the invisible light, and
the processor generates the first pupil image based on light incident on the first filter at the time of emission of the first light, generates the second pupil image based on light incident on the first filter and the second filter at the time of emission of the second light, and detects the phase difference between the first pupil image and the second pupil image.

11. The imaging device as defined in claim 10, wherein
the processor
performs a signal level adjustment process on a signal of the light incident on the first filter at the time of emission of the second light, and
generates the second pupil image based on the signal having undergone the signal level adjustment process and a signal of the light incident on the second filter at the time of emission of the second light.

12. The imaging device as defined in claim 10, wherein
the processor
performs an adjustment control to adjust an emission amount of at least one of the first light and the second light from the light source, and
detects the phase difference between the first pupil image and the second pupil image based on the emission of the first light and the second light after the adjustment control.

13. An imaging device comprising:
an optical filter that divides a pupil of an imaging optical system into a first pupil and a second pupil different in transmission wavelength band of light;
an image sensor in which a first filter transmitting light in the transmission wavelength band of the first pupil and a second filter transmitting light in the transmission wavelength band of the second pupil are arranged two-dimensionally; and
a first light source that emits the light in the transmission wavelength band of the first pupil and a second light source that emits the light in the transmission wavelength band of the second pupil, wherein
the first light source and the second light source emit light in a time-division manner, and
a phase difference between an image generated based on light incident on the first filter at the time of emission from the first light source and an image generated based on light incident on the second filter at the time of emission from the second light source is detected.

14. An imaging method comprising:
based on light having passed through an optical filter that divides a pupil of an imaging optical system into a first pupil that transmits visible light and a second pupil that transmits invisible light,
generating a first pupil image as an image of the visible light;
generating a second pupil image as an image of the invisible light; and
detecting a phase difference between the first pupil image and the second pupil image.

15. An imaging method using an imaging optical system that has an optical filter to divide a pupil of the imaging optical system into a first pupil and a second pupil different in transmission wavelength band of light, wherein
the imaging method comprises:
causing a first light source to emit light in the transmission wavelength band of the first pupil and a second light source to emit light in the transmission wavelength band of the second pupil in a time-division manner;
generating a first pupil image based on light incident on a first filter that transmits the light in the transmission wavelength band of the first pupil in the image sensor at the time of emission from the first light source;
generating a second pupil image based on light incident on the second filter that transmits the light in the transmission wavelength band of the second pupil in the image sensor at the time of emission from the second light source; and
detecting a phase difference between the first pupil image and the second pupil image.

16. An information storage device that stores a program for causing a computer to execute a process of a signal based on light having passed through an optical filter to divide a pupil of an imaging optical system into a first pupil and a second pupil different in transmission wavelength band of light,
the program causing the computer to execute the steps of:
causing a first light source to emit light in the transmission wavelength band of the first pupil and a second light source to emit light in the transmission wavelength band of the second pupil in a time-division manner;
generating a first pupil image based on light incident on a first filter that transmits the light in the transmission wavelength band of the first pupil in the image sensor at the time of emission from the first light source;
generating a second pupil image based on light incident on the second filter that transmits the light in the transmission wavelength band of the second pupil in the image sensor at the time of emission from the second light source; and
detecting a phase difference between the first pupil image and the second pupil image.
